(19) United States
(12) Patent Application Publication
(10) Pub. No.: US 2025/0065366 A1
(43) Pub. Date: Feb. 27, 2025

(54) MANAGING SPATIALLY-DEPENDENT MODULATION FOR LASER-ASSISTED DEPOSITION

(71) Applicant: Ciena Corporation, Hanover, MD (US)

(72) Inventors: Jean-Philippe Bérubé, Saint-Augustin (CA); Jean-Sébastien Côté, Québec (CA)

(73) Assignee: Ciena Corporation, Hanover, MD (US)

(21) Appl. No.: 18/455,184

(22) Filed: Aug. 24, 2023

(51) Int. Cl. B05D 3/06; B23K 26/0622; B23K 26/064

(52) U.S. Cl. CPC B05D 3/06; B23K 26/0622; B23K 26/064

(57) ABSTRACT

A coherent light source is configured to output an optical wave. An optical modulation module is configured to provide spatially-dependent modulations to at least one of (1) a phase or (2) an amplitude of the optical wave, thereby resulting in a modified optical wave. A dispensing structure comprises a substrate bonded to one or more deposition materials capable of being ejected from the substrate, or in conjunction with a portion of the substrate, by exposure to an optical intensity above a threshold. The spatially-dependent modulations are determined based at least in part on a target intensity profile of the modified optical wave at a surface of or within the dispensing structure.

### TECHNICAL FIELD

This disclosure relates to managing spatially-dependent modulation for laser-assisted deposition.

### BACKGROUND

Complementary metal-oxide-semiconductor (CMOS) and other fabrication techniques are generally used to fabricate electronic integrated circuits (EICs), which operate using electrical signals (e.g., voltage signals and/or current signals). Similar fabrication techniques can be used to fabricate photonic integrated circuits (PICs) in SiPhot or other photonic platforms. PICs often include optical waveguides for transporting optical waves to and from photonic devices.

As electrical and opto-electrical devices increase in complexity due to co-packaging and hybrid integration, designers are often faced with the challenge of integrating several IC chips in a single device or product. Adhesive materials can be used in the process of integrated circuit fabrication. For example, some adhesive materials are composed of organic materials that are a viscous liquid in an initial state and can be cured to transform into a relatively hard and/or solid state. For some uses, the adhesive materials are optical adhesives that have a relatively high transmittance (e.g., at least 80%).

### SUMMARY

In one aspect, in general, an apparatus comprises: a coherent light source configured to output an optical wave; an optical modulation module configured to provide spatially-dependent modulations to at least one of (1) a phase or (2) an amplitude of the optical wave, thereby resulting in a modified optical wave; and a dispensing structure comprising a substrate bonded to one or more deposition materials capable of being ejected from the substrate, or in conjunction with a portion of the substrate, by exposure to an optical intensity above a threshold; wherein the spatially-dependent modulations are determined based at least in part on a target intensity profile of the modified optical wave at a surface of or within the dispensing structure.

Aspects can include one or more of the following features.

The apparatus further comprises a target upon which the deposition materials are deposited onto after being ejected.

The target intensity profile of the modified optical wave at the surface of or within the dispensing structure is determined based at least in part on a deposition pattern to be formed on the target by the deposition materials after being ejected from the substrate.

The deposition pattern to be formed on the target by the deposition materials after being ejected is formed by a single pulse of the modified optical wave.

The spatially-dependent modulations are further determined based at least in part on at least one of (1) a shape of the target, (2) an orientation of the target, (3) a shape of the dispensing structure, (4) an orientation of the dispensing structure, or (5) a separation of the target from the dispensing structure.

The spatially-dependent modulations are further determined based at least in part on an inverse Fourier transform of the target intensity profile of the modified optical wave at the surface of or within the dispensing structure.

The substrate is optically transmissive.

The dispensing structure is configured to continuously replace the substrate by additional substrate that has not been previously exposed to an optical intensity above the threshold.

The target intensity profile of the modified optical wave at the surface of or within the dispensing structure is non-Gaussian.

The target intensity profile of the modified optical wave at the surface of or within the dispensing structure comprises two or more regions of intensities larger than the threshold separated by one or more regions of intensities lower than the threshold.

The target intensity profile of the modified optical wave at the surface of or within the dispensing structure comprises one or more regions of intensities larger than the threshold and smaller than one micron in diameter.

The deposition material comprises an adhesive material.

The optical modulation module comprises a spatial light modulator.

In another aspect, in general, a method for dispensing one or more deposition materials from a dispensing structure using an optical wave from a coherent light source comprises: determining spatially-dependent modulations based at least in part on a target intensity profile of a modified optical wave at a surface of or within the dispensing structure; providing spatially-dependent modulations to at least one of (1) a phase or (2) an amplitude of the optical wave to yield the modified optical wave at a surface of or within the dispensing structure; and ejecting portions of one or more deposition materials bonded to a substrate of the dispensing structure from the substrate, or in conjunction with a portion of the substrate, by exposure to an optical intensity above a threshold produced by the modified optical wave.

Aspects can include one or more of the following features.

The method further comprises receiving the ejected portions of the deposition materials onto a target.

The method further comprises determining the target intensity profile of the modified optical wave at the surface of or within the dispensing structure based at least in part on a deposition pattern to be formed on the target by the deposition materials after being ejected from the substrate.

The deposition pattern to be formed on the target by the deposition materials after being ejected is formed by a single pulse of the modified optical wave.

The target intensity profile of the modified optical wave at the surface of or within the dispensing structure comprises two or more regions of intensities larger than the threshold separated by one or more regions of intensities lower than the threshold.

The target intensity profile of the modified optical wave at the surface of or within the dispensing structure comprises one or more regions of intensities larger than the threshold and smaller than one micron in diameter.

In another aspect, in general, a product comprises one or more deposition materials deposited on a portion of the product according to a method for dispensing the one or more deposition materials from a dispensing structure using an optical wave from a coherent light source. The method comprises determining spatially-dependent modulations based at least in part on a target intensity profile of a modified optical wave at a surface of or within the dispensing structure; providing spatially-dependent modulations to at least one of (1) a phase or (2) an amplitude of the optical wave to yield the modified optical wave at a surface of or within the dispensing structure; and ejecting portions of one or more deposition materials bonded to a substrate of the dispensing structure from the substrate, or in conjunction with a portion of the substrate, by exposure to an optical intensity above a threshold produced by the modified optical wave, to form at least one portion of at least one of the one or more deposition materials that has a size after deposition on the product that is smaller than one micron.

Aspects can have one or more of the following advantages.

The subject matter disclosed herein may enhance the speed and accuracy for depositing materials onto a surface (e.g., of a mounting substrate, an electrical chip, or a photonic integrated circuit) and has broad applicability to the micro-electronics industry. In some examples, the material can be an adhesive that is to be bonded to the surface. For example, the disclosed techniques and devices may be faster than point-by-point deposition techniques by using fewer laser-assisted dispensing interactions (or “laser shots”) and, in some cases, may use a single laser shot to dispense adhesive on all of the desired portions of a product. Additional elements may then be placed in contact with the adhesive so as to bind the elements to the product. The subject matter disclosed may also allow for an improvement in the efficiency of the dispensing process by providing better control of the adhesive quantity needed to achieve proper adhesion.

The subject matter disclosed herein may also reduce the smallest possible feature size of the deposited material, possibly by a factor of ten over the smallest spots achieved with point-by-point techniques (e.g., comprising translation stages in conjunction with a high magnification objective). For example, the subject matter disclosed may utilize an interference pattern to create features that are on the order of half a wavelength of the optical wave (e.g., 500 nm for a 1 μm laser).

Thus, the subject matter disclosed herein may overcome existing limitations in processing speed, accuracy, and efficiency associated with conventional dispensing and laser-assisted deposition schemes. Accordingly, such benefits may result in a reduction of cost for assembly.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A, 1B, 1C, 1D, 1E, and 1F show schematic diagrams of example spatially-dependent modulated laser assisted deposition (SMLAD) configurations.

FIG. 2 shows a schematic diagram of an example spatial light modulator (SLM) control system.

FIG. 3A shows a schematic diagram of an example adhesive dispense pattern for a mounting substrate of an example product.

FIG. 3B shows a schematic diagram of an example adhesive dispense pattern for a portion of a mounting substrate of an example product.

FIGS. 4A, 4B, 4C, 4D, 4E and 4F show example intensity profiles generated by an optical spatially-dependent modulating device (OSMD).

### DETAILED DESCRIPTION

Continuous laser assisted dispensing (CLAD) techniques allow for material, typically an adhesive, to be deposited onto a surface (e.g., of a chip or component) by scanning a laser (i.e., point-by-point deposition). CLAD techniques utilize laser induced forward transfer (LIFT), wherein the laser energy of a pulsed optical beam is used as a driving force to project a material. For example, LIFT can be used to project an adhesive from a foil-adhesive interface by providing laser energy at a focus point that is locally absorbed by the foil such that a drop of adhesive is projected away from the foil. The foil may be continuously moved (e.g., using rollers) to provide a new layer of adhesive that has not already been ejected from the foil.

The subject matter disclosed herein includes techniques for controlling an optical intensity profile of a coherent optical wave used for applying light induced forward transfer to one or more materials. In some examples, the material is an adhesive material. As used herein, the term “adhesive material” refers to the adhesive material in any state, including a state before, during, or after curing. Before and during dispensing of the adhesive material, the adhesive material can be in a liquid or semi-liquid state with a relatively low viscosity. During and after curing of the adhesive material, the adhesive material can be in a semi-cured or cured state that has a relatively higher viscosity, or is no longer flowing and/or has an increased hardness.

In some implementations, the material may need to be controlled within areas as small as 1 mm×0.3 mm, or even smaller, including areas as small as 50 μm×50 μm, for example. In some implementations, adhesive may be distributed so as to have specific optical properties over optical structures (e.g., waveguides). The adhesive can be cured by UV illumination or thermally as it reaches its equilibrium state governed by the surface tension of the substrate onto which it is deposited, for example.

The intensity profile may be controlled by an optical spatially-dependent modulating device (OSMD) that can apply spatially-dependent modulation to at least one of (1) the phase or (2) the amplitude associated with the optical wave. The modulation of phase and/or amplitude is spatially-dependent such that the changing phase and/or amplitude depends on the spatial coordinates over the transverse profile of the optical wave. Such devices include spatial light modulators (SLMs) and holograms (also referred to as holographic plates). An amplitude modulation hologram modulates the amplitude of the optical wave diffracted by the hologram while a phase modulation hologram modulates the phase of the optical wave diffracted from the hologram. A phase hologram may be designed to modulate the phase of the optical wave by varying either the thickness or the refractive index of the hologram. SLMs also may be designed to modulate the phase and/or the intensity of the optical wave, with some SLMs utilizing liquid crystals to generate the spatially-dependent modulation of the optical wave. Both holograms and SLMs can be designed to operate in reflection or in transmission. While SLMs can be adjusted during operation (i.e., the intensity profile can be modified in real time), holograms are generally static devices, unless externally translated spatially. In some examples, it may be preferable to utilize holograms due to their possibly simpler experimental realization, especially if a machine or apparatus is not responsible for numerous different deposition tasks with different corresponding intensity profiles. Thus, holograms can be particularly advantageous for high volume production purposes.

In some examples disclosed herein, an OSMD can modify an optical wave to control an intensity profile of the optical wave traversing through a dispensing structure comprising a substrate (e.g., a transparent foil) that is bonded to one or more deposition materials (e.g., adhesives). The control of the intensity profile of the optical wave traversing through the dispensing structure correspondingly allows for control over the spatial distribution of deposition materials that are ejected from the dispensing structure toward a target (e.g., a photonic chip or a mounting substrate on which parts are to be installed). The resulting spatial distribution of deposition materials may be more precise than existing techniques and may provide control over adhesive dispense at the micron-level. In some example implementations, adhesive dispense patterns as large as a typical mounting substrate and have very sharp micron-sized features that can be generated using a single laser shot.

The deposition pattern may be tailored to fit the shape or physical characteristics of chips, small electronic components, and free space optics (e.g., such as those used in high-speed photonics components (HSPC) products). Since adhesive dispensing can be an extensively used process in the fabrication of components, the ability to dispense adhesive using few laser pulses may result in significant gains in processing speed, efficiency, and yield. In some examples, such control of the intensity profile afford by an OSMD allows for single laser shot dispensing of a possibly complex adhesive pattern over a mm-scale area with micron-level precision. By utilizing an OSMD, a surface as large or larger than a typical mounting substrate used in component fabrication may be patterned with adhesive by a single laser shot. In other words, the whole portion of a mounting substrate surface that requires the presence of adhesive could be precisely covered with adhesive droplets by using a single laser shot. Such a capability may considerably speed up the installation of passive electronic or optical components in some products.

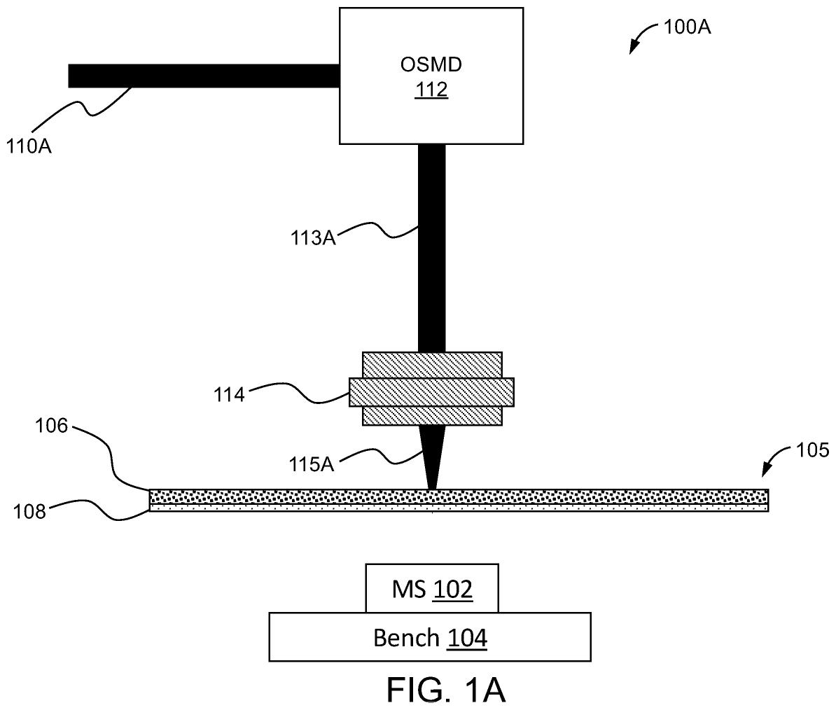

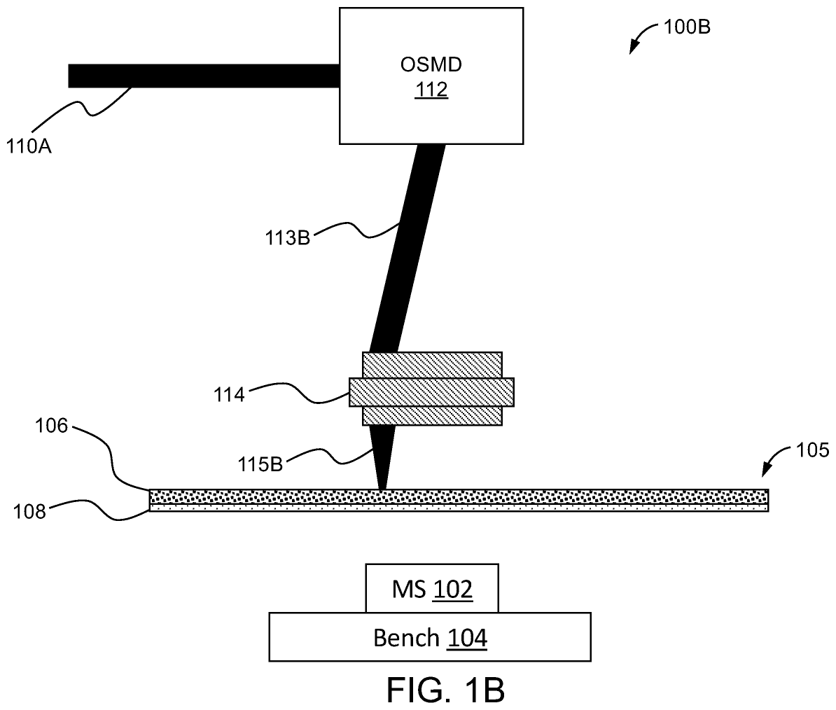

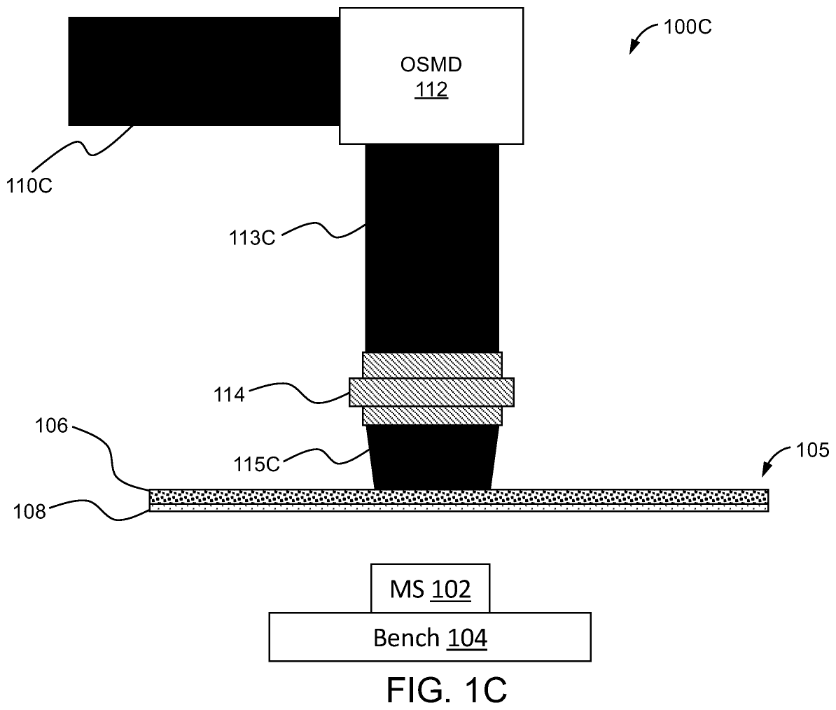

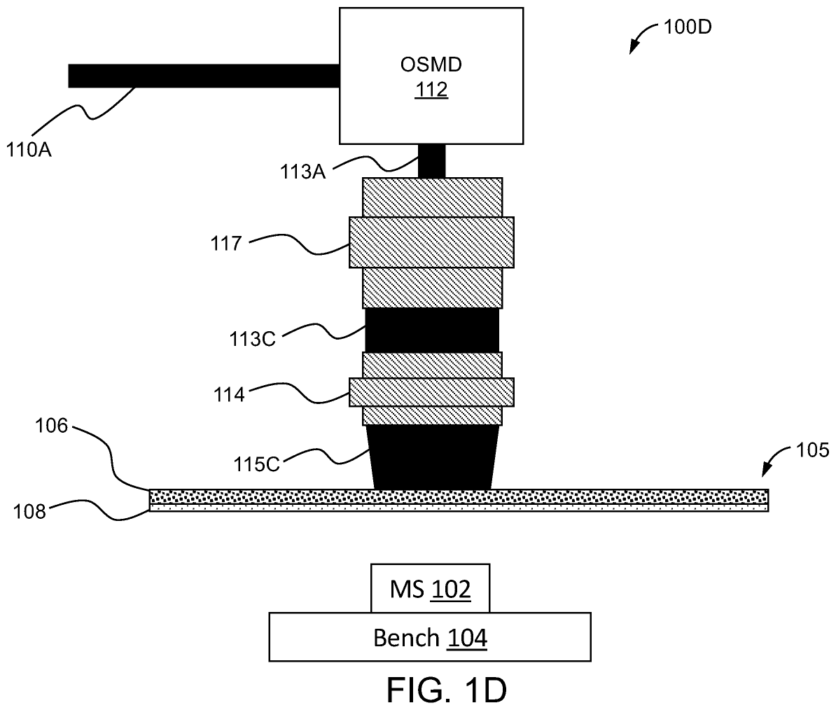

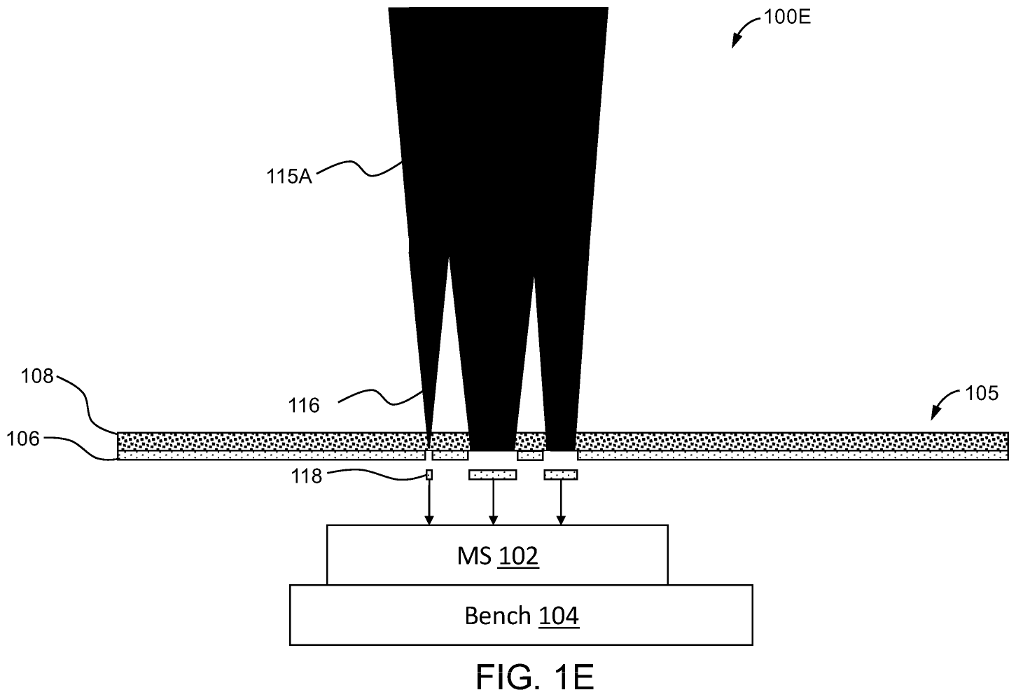

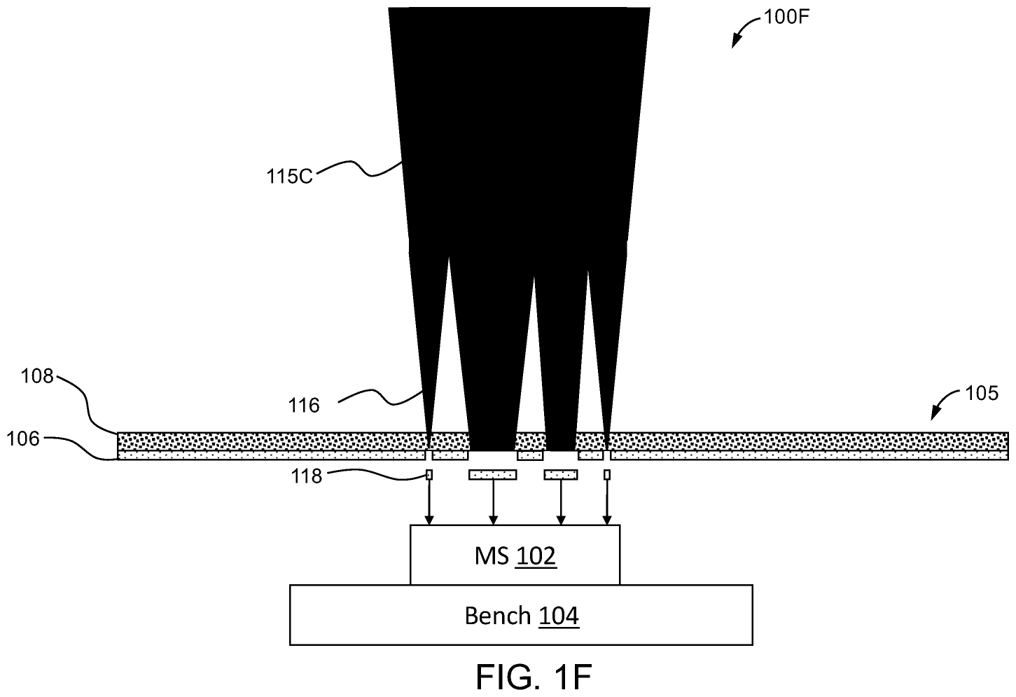

FIGS. 1A, 1B, 1C, 1D, 1E, and 1F show example spatially-dependent modulated laser assisted deposition (SMLAD) configurations. In each of these example configurations, a control device (not shown) coupled to the OSMD is able to determine spatially-dependent modulations to be applied based at least in part on a target intensity profile of a modified optical wave at a surface of or within a dispensing structure. The control device can include, for example, a computer having one or more processor cores, an application-specific integrated circuit, or other computing device capable of being programmed with input data specifying a desired target intensity profile of the modified optical wave based on the particular optical elements that will be included in the rest of the SMLAD configuration, as described in more detail below.

FIG. 1A shows an example SMLAD configuration 100A comprising a mounting substrate 102 (MS) located on top of a bench 104. A dispensing structure 105 comprising a transparent foil 106 bonded to an adhesive 108 is located above the mounting substrate 102. An optical wave 110A is provided by a coherent light source (not shown) and is spatially modulated by an OSMD 112, resulting in a spatially modulated optical wave 113A. In some implementations, the coherent light source is a laser. Alternatively, any other source of a coherent optical wave could be used. The spatially modulated optical wave 113A then traverses through a focusing element 114 (e.g., one or more lenses), resulting in a focused spatially modulated optical wave 115A that impinges on the dispensing structure 105. The focusing element 114 may be located a focal length away from the dispensing structure 105 so that the focused spatially modulated optical wave 115A is at its most focused (i.e., its beam waist). In some examples, the focusing element 114 may be absent, such that the spatially modulated optical wave 113A instead impinges on the dispensing structure 105. In examples where the focusing element 114 is absent, the OSMD 112 may be configured to output the focused spatially modulated optical wave 115A directly, which may be accomplished by applying appropriate spatially-dependent phase modulation to achieve desired wavefront curvature. For example, the OSMD 112 may be placed near the dispensing structure 105 (e.g., where a lens may normally be located) and be configured to focus light to achieve a beam waist similar to that of the replaced lens or focusing element. In general, the angle between the propagation direction optical wave 110A and the propagation direction of the spatially modulated optical wave 113A can depend on the OSMD 112 and any additional optical elements. In some examples, the dispensing structure 105 may be continuously moved (e.g., using rollers) to provide a new layer of adhesive 108 that has not already been ejected from the transparent foil 106. In other implementations, any other substrate could potentially be used in place of the transparent foil 106. For example, any other substrate that is optically transmissive (i.e., with an optical transmittance of at least 50%, or higher such as a transmittance of greater than 90%), and from which the adhesive or other deposition material is capable of being ejected (after being temporarily bonded to the substrate), could be used.

FIG. 1B shows an example SMLAD configuration 100B comprising a mounting substrate 102 located on top of a bench 104. A dispensing structure 105 comprising a transparent foil 106 bonded to an adhesive 108 is located above the mounting substrate 102. An optical wave 110A is provided by a coherent light source (not shown) and is spatially modulated by an OSMD 112, resulting in an angled spatially modulated optical wave 113B. The resulting angle can be controlled, for example, by using a mechanically steered element or by applying an appropriate spatially-dependent phase modulation. The angled spatially modulated optical wave 113B then traverses through a focusing element 114, resulting in a horizontally offset focused spatially modulated optical wave 115B that impinges on the dispensing structure 105. In some examples, the focusing element 114 may be absent, such that the angled spatially modulated optical wave 113B instead impinges on the dispensing structure 105. The position of the focusing element 114 may be chosen to be a focal length of the focusing element 114 away from the OSMD 112, such that the horizontally offset focused spatially modulated optical wave 115B impinges on the dispensing structure 105 at normal incidence.

FIG. 1C shows an example SMLAD configuration 100C comprising a mounting substrate 102 located on top of a bench 104. A dispensing structure 105 comprising a transparent foil 106 bonded to an adhesive 108 is located above the mounting substrate 102. A large optical wave 110C is provided by a coherent light source (not shown) and is spatially modulated by an OSMD 112, resulting in a large spatially modulated optical wave 113C. The large spatially modulated optical wave 113C then traverses through a focusing element 114, resulting in a large focused spatially modulated optical wave 115C that impinges on the dispensing structure 105. In some examples, the focusing element 114 may be absent, such that the large spatially modulated optical wave 113C instead impinges on the dispensing structure 105. In examples where the focusing element 114 is absent, the OSMD 112 may be configured to output the large focused spatially modulated optical wave 115C directly.

FIG. 1D shows an example SMLAD configuration 100D comprising a mounting substrate 102 located on top of a bench 104. A dispensing structure 105 comprising a transparent foil 106 bonded to an adhesive 108 is located above the mounting substrate 102. An optical wave 110A is provided by a coherent light source (not shown) and is spatially modulated by an OSMD 112, resulting in a spatially modulated optical wave 113A. The spatially modulated optical wave 113A then traverses through a beam expanding element 117 (e.g., two lenses arranged to form a telescope), resulting in a large spatially modulated optical wave 113C. The large spatially modulated optical wave 113C then traverses through a focusing element 114, resulting in a large focused spatially modulated optical wave 115C that impinges on the dispensing structure 105.

FIG. 1E shows a portion of an example SMLAD configuration 100E comprising a mounting substrate 102 located on top of a bench 104. A dispensing structure 105 comprising a transparent foil 106 bonded to an adhesive 108 is located above the mounting substrate 102. A focused spatially modulated optical wave 115A (e.g., as shown in FIG. 1A) impinges on the dispensing structure 105. The intensity profile of the focused spatially modulated optical wave 115A has three maxima 116 that each have an optical intensity above a threshold. The threshold may depend on the foil 106, the adhesive 108, and the wavelength of the large focused spatially modulated optical wave 115C. The three maxima 116 eject the adhesive 108 from the dispensing structure 105, resulting in three pieces of ejected adhesive 118 that are deposited onto the mounting substrate 102.

FIG. 1F shows a portion of an example SMLAD configuration 100F comprising a mounting substrate 102 located on top of a bench 104. A dispensing structure 105 comprising a transparent foil 106 bonded to an adhesive 108 is located above the mounting substrate 102. A large focused spatially modulated optical wave 115C (e.g., as shown in FIGS. 1C and 1D) impinges on the dispensing structure 105. In this example, the intensity profile of the large focused spatially modulated optical wave 115C has four maxima 116 that each have an optical intensity above a threshold. The threshold may depend on the foil 106, the adhesive 108, and the wavelength of the large focused spatially modulated optical wave 115C. The four maxima 116 eject the adhesive 108 from the dispensing structure 105, resulting in four pieces of ejected adhesive 118 that are deposited onto the mounting substrate 102. In general, the number of possible intensity maxima can depend on characteristics of the OSMD used (e.g., the periodicity of a holographic grating or the pixel size of an SLM) and may be substantially greater than the four maxima used in this example.

By utilizing an OSMD it is possible, through the spatially-dependent modulation of the intensity and/or phase of an optical wave, to generate complex two-dimensional (2D) adhesive dispense patterns with possibly sub-micron accuracy (e.g., patterns of deposited material with a pitch or other width of any feature of the pattern having a size less than about 1.0 μm, or less than about 0.5 μm). In some examples a focusing element (e.g., focusing element 114 in FIGS. 1A, 1B, 1C, and 1D) is located between the OSMD and the target surface onto which deposition is desired. In such examples, in order to obtain a desired intensity pattern at the focus of the focusing element, an inverse Fourier transform of the pattern can be computed and used to determine the spatially-dependent modulations applied by the OSMD. Such a computation can be useful because the intensity profile of the optical wave at the focusing element is related to the intensity profile of the optical wave at the focus of the focusing element by a Fourier transform. In examples where a beam expanding element is included (e.g., the beam expanding element 117 shown in FIG. 1D), the magnification provided by the beam expanding element can be included in the determination of the spatially-dependent modulations applied by the OSMD. Similarly, any other optical elements included in the beam propagation path between the OSMD 112 and the location of the dispensing structure 105 can be included to determine the spatially-dependent modulations applied by the OSMD. Or if there are no optical elements in the path (e.g., no focusing element), the relationship may simply include the diffraction of the beam during free-space propagation over the appropriate distance.

Although planar surfaces and dispensing structures are shown in FIGS. 1A, 1B, 1C, 1D, and 1E, in some examples the dispensing structure or the target surface onto which deposition is desired may have portions with different heights, curvature, or an otherwise non-planar shape or volume. Thus, in general the spatially-dependent modulations applied by the OSMD can depend on the shape of the target surface, the orientation of the target surface, the shape of the dispensing structure, the orientation of the dispensing structure, or the separation of the target surface from the dispensing structure.

In some examples, two or more materials (e.g., adhesives) may have distinct properties that can be utilized by the target surface. In such examples, the dispensing structure can be configured to allow for the deposition of both materials, possibly simultaneously. For example, a first portion of the target surface may be deposited with a first adhesive supplied by a first portion of the dispensing structure, while a second portion of the target surface may be deposited with a second adhesive supplied by a second portion of the dispensing structure. For example, the first portion of the dispensing structure can correspond to a circular shape and the second portion of the dispensing structure can correspond to an annulus surrounding the first portion. In another example, the first portion of the dispensing structure can correspond to a first rectangle and the second portion to a second rectangle that does not overlap with the first rectangle.

An example procedure for installing components using SMLAD may comprise the following steps. First, determine the position and dimensions of the components to be installed, for example from a drawing. Second, determine the intensity profile desired to match the position and dimensions of the components and/or their adhesive dispense patterns. As described previously, in order to obtain a desired intensity pattern at the focus of a focusing element, the inverse Fourier transform of the pattern can be computed. Third, perform SMLAD, wherein the adhesive distribution and quantity are dictated by the intensity pattern produced by the OSMD and an optional focusing element. Fourth, install the components and perform adhesive curing. Other procedures could use more, or fewer, steps, and/or a different order of steps.

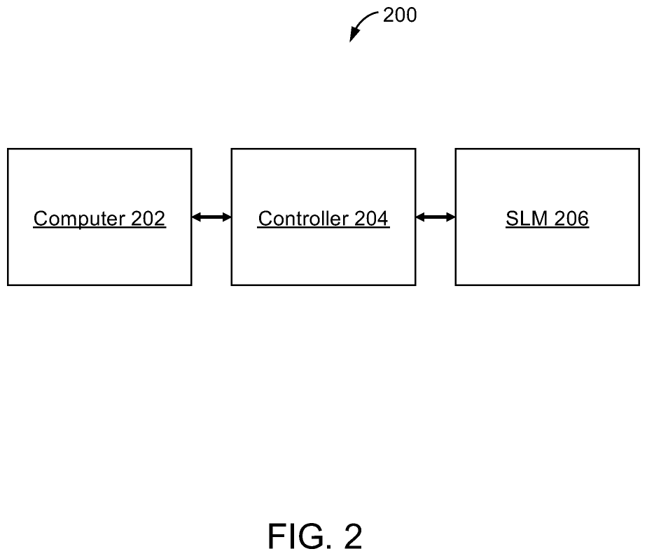

FIG. 2 shows an example SLM control system 200. A computer 202 is in electrical communication with a controller 204 that is in electrical communication with an SLM 206. In some examples, a calibration signal from light spatially modulated by the SLM 206 (e.g., from one or more photodiodes or charge-coupled devices (CCDs)) may be sent to the controller 204 or the computer 202 to assist with real-time feedback used to calibrate the SLM 206, or as part of a calibration performed prior to a production run. In other examples, the feedback used to calibrate the SLM 206 can comprise observing a pattern formed on a dispensing structure to determine if the OSMD is performing as intended, and thus a calibration signal is not necessarily used in other examples.

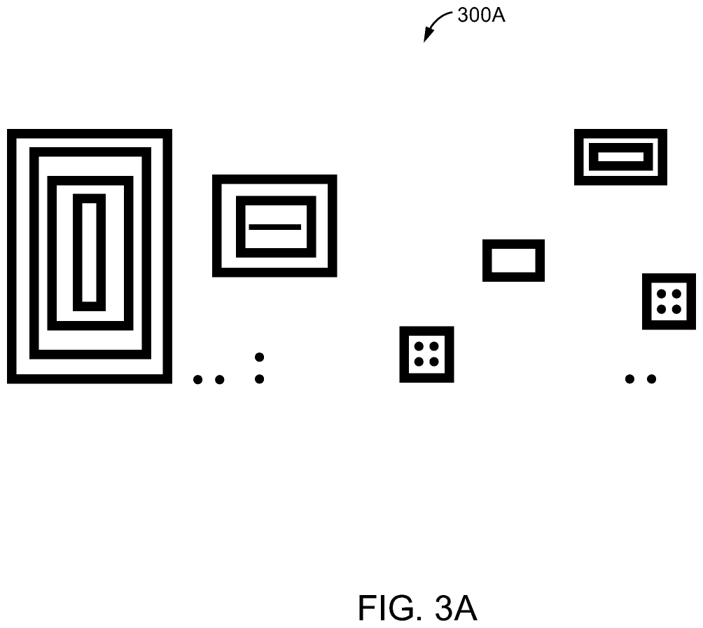

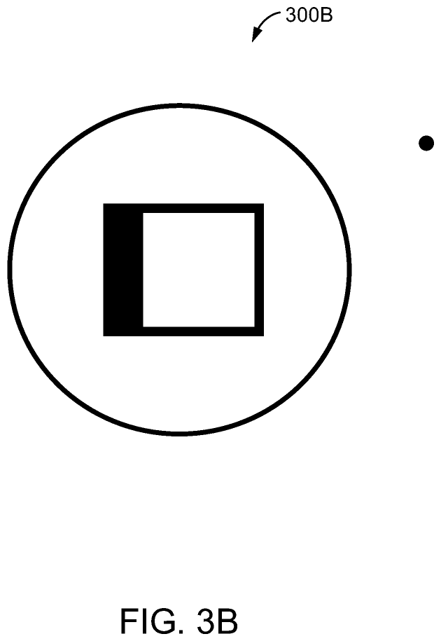

FIG. 3A shows an example adhesive dispense pattern 300A for a mounting substrate of an example product. SMLAD configurations, such as those shown in FIGS. 1A, 1B, 1C, and 1D, can be used to dispense adhesive in fewer laser pulses than point-by-point deposition methods, and may even dispense all of the adhesive in one laser shot in some examples.

FIG. 3B shows an example adhesive dispense pattern 300B for a portion of a mounting substrate of an example pattern of adhesive distribution for mounting photonic elements to a surface of a mounting substrate.

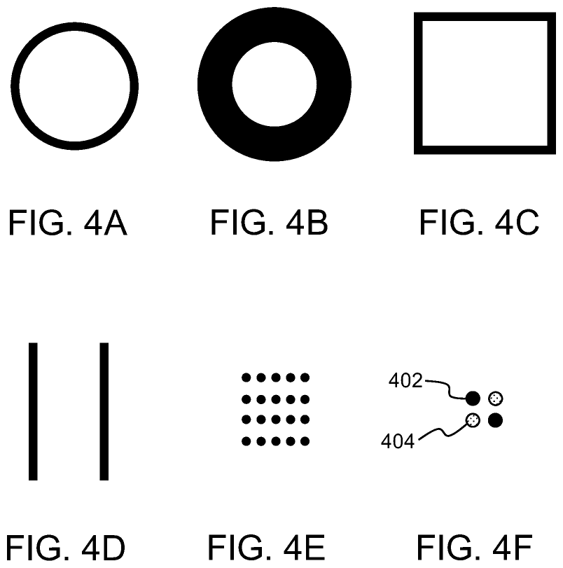

FIGS. 4A, 4B, 4C, 4D, 4E and 4F show example intensity profiles generated by an OSMD. In some examples, the intensity profiles correspond to an optical wave while it traverses through a dispensing structure. In such examples, the optical wave may eject material from the dispensing structure based on a threshold that can depend on the intensity profile, the wavelength of the optical wave, and the dispensing structure.

FIG. 4F shows an intensity profile comprising features of a first optical intensity 402 and features of a second optical intensity 404. In general, such control over the intensity profile may also be applied to the intensity profiles shown in FIGS. 4A, 4B, 4C, 4D, and 4E. In some examples, the intensity profile generated by an OSMD and at the surface of or within the dispensing structure may be non-Gaussian, comprise two or more regions of intensities larger than the threshold separated by one or more regions of intensities lower than the threshold, or comprise one or more regions of intensities larger than the threshold and smaller than a micron in diameter.

Some examples of point-by-point CLAD comprise directing an optical wave to a foil-adhesive interface by using computer-controlled translation stages or galvanometric scanning mirror in between laser pulses. Such techniques can have a trade-off between deposition speed and the smallest achievable feature size, depending on whether a translation stage or a galvanometric scanning mirror is used. For example, a translation stage can be translated at a typical speed on the order of 1 mm/s and, when combined with a 100× focusing objective, can theoretically produce a smallest possible spot size of 1 μm. In comparison, a galvanometric scanning mirror can be translated at a typical speed on the order of 1 m/s and theoretically can produce a smallest possible spot size of 10 μm. The aforementioned values reflect theoretical best possible values. In practice, the smallest possible feature size may be larger. For example, one commercially available option comprises a galvanometric scanning mirror and specifies a 20 μm resolution for dispensed adhesive. Furthermore, implementing a translation stage in conjunction with a 100× objective in the context of fast processing and limited set-up space can be challenging. In practice, a 20× objective with a 5 μm spot size may instead be more feasible.

In contrast, in some examples, SMLAD may be applied to produce adhesive droplets with very fine features. Theoretically, features could be as small as half the wavelength of the optical wave used for ejecting adhesive droplets (i.e., diffraction limited). The smallest possible feature size may in practice be limited by the viscosity of the applied adhesive. Thus, adhesive dispense patterns comprising complex shapes and sharp features can be produced using SMLAD.

In some examples, adhesive deposition using SMLAD may be highly efficient, since the enhanced precision over adhesive dispense translates to less adhesive wasted during deposition. Furthermore, SMLAD may provide a gain in repeatability and consistency of the quantity of dispensed adhesive. For example, finer control over the adhesive distribution, in regards to the physical characteristics of parts to be attached, can lead to the optimization of the quantity of adhesive necessary for sufficient coverage, and thus proper adhesion. In a similar manner, the strength of adhesion may be improved by a finer adjustment of adhesive distribution.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. An apparatus comprising:
a coherent light source configured to output an optical wave;
an optical modulation module configured to provide spatially-dependent modulations to at least one of (1) a phase or (2) an amplitude of the optical wave, thereby resulting in a modified optical wave; and
a dispensing structure comprising a substrate bonded to one or more deposition materials capable of being ejected from the substrate, or in conjunction with a portion of the substrate, by exposure to an optical intensity above a threshold;
wherein the spatially-dependent modulations are determined based at least in part on a target intensity profile of the modified optical wave at a surface of or within the dispensing structure.

2. The apparatus of claim 1, further comprising a target upon which the deposition materials are deposited onto after being ejected.

3. The apparatus of claim 2, wherein the target intensity profile of the modified optical wave at the surface of or within the dispensing structure is determined based at least in part on a deposition pattern to be formed on the target by the deposition materials after being ejected from the substrate.

4. The apparatus of claim 3, wherein the deposition pattern to be formed on the target by the deposition materials after being ejected is formed by a single pulse of the modified optical wave.

5. The apparatus of claim 2, wherein the spatially-dependent modulations are further determined based at least in part on at least one of (1) a shape of the target, (2) an orientation of the target, (3) a shape of the dispensing structure, (4) an orientation of the dispensing structure, or (5) a separation of the target from the dispensing structure.

6. The apparatus of claim 1, wherein the spatially-dependent modulations are further determined based at least in part on an inverse Fourier transform of the target intensity profile of the modified optical wave at the surface of or within the dispensing structure.

7. The apparatus of claim 1, wherein the substrate is optically transmissive.

8. The apparatus of claim 1, wherein the dispensing structure is configured to continuously replace the substrate by additional substrate that has not been previously exposed to an optical intensity above the threshold.

9. The apparatus of claim 1, wherein the target intensity profile of the modified optical wave at the surface of or within the dispensing structure is non-Gaussian.

10. The apparatus of claim 1, wherein the target intensity profile of the modified optical wave at the surface of or within the dispensing structure comprises two or more regions of intensities larger than the threshold separated by one or more regions of intensities lower than the threshold.

11. The apparatus of claim 1, wherein the target intensity profile of the modified optical wave at the surface of or within the dispensing structure comprises one or more regions of intensities larger than the threshold and smaller than one micron in diameter.

12. The apparatus of claim 1, wherein the deposition material comprises an adhesive material.

13. The apparatus of claim 1, wherein the optical modulation module comprises a spatial light modulator.

14. A method for dispensing one or more deposition materials from a dispensing structure using an optical wave from a coherent light source, the method comprising:
determining spatially-dependent modulations based at least in part on a target intensity profile of a modified optical wave at a surface of or within the dispensing structure;
providing spatially-dependent modulations to at least one of (1) a phase or (2) an amplitude of the optical wave to yield the modified optical wave at a surface of or within the dispensing structure; and
ejecting portions of one or more deposition materials bonded to a substrate of the dispensing structure from the substrate, or in conjunction with a portion of the substrate, by exposure to an optical intensity above a threshold produced by the modified optical wave.

15. The method of claim 13, further comprising receiving the ejected portions of the deposition materials onto a target.

16. The method of claim 14, further comprising determining the target intensity profile of the modified optical wave at the surface of or within the dispensing structure based at least in part on a deposition pattern to be formed on the target by the deposition materials after being ejected from the substrate.

17. The method of claim 15, wherein the deposition pattern to be formed on the target by the deposition materials after being ejected is formed by a single pulse of the modified optical wave.

18. The method of claim 13, wherein the target intensity profile of the modified optical wave at the surface of or within the dispensing structure comprises two or more regions of intensities larger than the threshold separated by one or more regions of intensities lower than the threshold.

19. The method of claim 13, wherein the target intensity profile of the modified optical wave at the surface of or within the dispensing structure comprises one or more regions of intensities larger than the threshold and smaller than one micron in diameter.

20. A product comprising one or more deposition materials deposited on a portion of the product according to a method for dispensing the one or more deposition materials from a dispensing structure using an optical wave from a coherent light source, the method comprising:
determining spatially-dependent modulations based at least in part on a target intensity profile of a modified optical wave at a surface of or within the dispensing structure;
providing spatially-dependent modulations to at least one of (1) a phase or (2) an amplitude of the optical wave to yield the modified optical wave at a surface of or within the dispensing structure; and
ejecting portions of one or more deposition materials bonded to a substrate of the dispensing structure from the substrate, or in conjunction with a portion of the substrate, by exposure to an optical intensity above a threshold produced by the modified optical wave, to form at least one portion of at least one of the one or more deposition materials that has a size after deposition on the product that is smaller than one micron.
